(19) United States
(12) Patent Application Publication
(10) Pub. No.: US 2025/0357851 A1
(43) Pub. Date: Nov. 20, 2025

(54) CLAMP CIRCUITRY FOR SWITCH MODE CONVERTER

(71) Applicant: TEXAS INSTRUMENTS INCORPORATED, Dallas, TX (US)

(72) Inventor: Pavol Balaz, San Francisco, CA (US)

(21) Appl. No.: 19/188,861

(22) Filed: Apr. 24, 2025

Related U.S. Application Data
(60) Provisional application No. 63/647,664, filed on May 15, 2024.
(60) Provisional application No. 63/647,656, filed on May 15, 2024.

(51) Int. Cl. H02M 1/34; H02M 3/158

(52) U.S. Cl. CPC H02M 1/342; H02M 3/158

(57) ABSTRACT

A clamp circuit comprising a transistor coupled between a first current terminal and a second current terminal, the transistor having a transistor control terminal; and a driver circuit having a driver input and a driver output. The circuit includes a pull-up circuit having a first bias terminal, a pull-up control input and a pull-up output, the first bias terminal coupled to a power terminal, the pull-up control input coupled to the driver output, and the pull-up output coupled to the transistor control terminal. The first further includes a pull-down circuit having a second bias terminal, a first pull-down control input, a second pull-down control input, and a pull-down output, the second bias terminal coupled to the second current terminal, the first pull-down control input coupled to the first current terminal, the second pull-down control input coupled to the driver output, and the pull-down output coupled to the transistor control terminal.

### CLAIM OF PRIORITY

This application claims priority to U.S. provisional patent application No. 63/647,656 titled “VDS Clamping Method for a Switching Power Converter” filed May 15, 2024. This application also claims priority to U.S. provisional patent application No. 63/647,664 titled “High Side (HS) to Low Side (LS) Switching for a Switching Power Converter” filed May 15, 2024. Both applications are incorporated by reference in their entirety.

### BACKGROUND

A switch mode power converter (e.g., a buck converter, a boost converter, a buck-boost converter) include transistors configured as switches to connect/disconnect between a power source and a power rail, which is coupled to a load, to set the amount of power transferred from the power source to the power rail. When the switch mode power converter switches, the commutation of current may induce voltage ringing on a power rail or switching node of the power converter due to parasitic inductance and capacitance (e.g., at the power rail, switching node, and the ground terminal) of the power converter. This ringing causes the voltage on the power supply rail or the switching node to overshoot, which can create voltage stress across the transistors of the power converter and degrade the reliability of the transistors. Also, charge stored in the parasitic capacitances of the transistors and switching node may be dissipated to the ground instead of being transferred to the power rail (and load), which can lead to power loss and reduce the efficiency of the power converter.

### SUMMARY

Described is an apparatus comprising a transistor coupled between a first current terminal and a second current terminal, the transistor having a transistor control terminal. The apparatus further comprises a driver circuit having a driver input and a driver output. In at least one example, the apparatus comprises a pull-up circuit having a first bias terminal, a pull-up control input and a pull-up output, the first bias terminal coupled to a power terminal, the pull-up control input coupled to the driver output, and the pull-up output coupled to the transistor control terminal. In at least one example, the apparatus comprises a pull-down circuit having a second bias terminal, a first pull-down control input, a second pull-down control input, and a pull-down output, the second bias terminal coupled to the second current terminal, the first pull-down control input coupled to the first current terminal, the second pull-down control input coupled to the driver output, and the pull-down output coupled to the transistor control terminal.

Described is a system comprising a load, an inductor coupled to the load, a capacitor coupled to the inductor and the load; and a DC-DC converter coupled to the inductor. In at least one example, the DC-DC converter comprises a transistor coupled between a first current terminal and a second current terminal, the transistor having a transistor control terminal. The DC-DC converter further comprises a driver circuit having a driver input and a driver output. In at least one example, the DC-DC converter comprises a pull-up circuit having a first bias terminal, a pull-up control input and a pull-up output, the first bias terminal coupled to a power terminal, the pull-up control input coupled to the driver output, and the pull-up output coupled to the transistor control terminal. In at least one example, the DC-DC converter further comprises a pull-down circuit having a second bias terminal, a first pull-down control input, a second pull-down control input, and a pull-down output, the second bias terminal coupled to the second current terminal, the first pull-down control input coupled to the first current terminal, the second pull-down control input coupled to the driver output, and the pull-down output coupled to the transistor control terminal.

In at least one example, a method for clamping overshoot is provided which comprises receiving a control signal to disable a transistor and receiving a first voltage from a current terminal of the transistor. In at least one example, the method comprises responsive to the control signal and the first voltage exceeding a threshold, setting a control terminal of the transistor to a second voltage to enable the transistor. In at least one example, the method comprises responsive to the first voltage being below the threshold, disabling the transistor.

Described is an apparatus comprising a transistor having a current terminal and a transistor control terminal. In at least one example, the apparatus further comprises a voltage transition sensing circuit having a sense input and a sense output, the sense input coupled to the current terminal. In at least one example, the apparatus comprises a control circuit having a control input and a control output, the control input coupled to the sense output, and the control output coupled to the transistor control terminal.

### BRIEF DESCRIPTION OF THE DRAWINGS

The examples will be understood more fully from the detailed description given below and from the accompanying drawings, which, however, should not be taken to limit the disclosure to the specific examples, but are for explanation and understanding only.

FIGS. 1, 2, and 3 are schematics illustrating a pull-down circuit with a drain-source voltage (VDS) clamp circuit for a transistor configured as a switch, in accordance with at least some examples.

FIG. 4 is a plot illustrating an operation of the clamp circuit and its impact on reducing ringing, in accordance with at least one example.

FIG. 5 is a schematic illustrating a dynamic reference generating circuit for the VDS clamp circuit, in accordance with at least one example.

FIG. 6 is a schematic illustrating a comparator for the VDS clamp circuit, in accordance with at least one example.

FIG. 7 is a schematic illustrating a system with VDS clamp circuits for a buck converter, in accordance with at least one example.

FIG. 8 is a schematic illustrating a system with VDS clamp circuits for a boost converter, in accordance with at least one example.

FIG. 9 is a plot illustrating operations of a buck converter, in accordance with at least one example.

FIG. 10 is a plot of examples of operation of a buck converter, such as buck converter of FIG. 7, in accordance with at least one example.

FIGS. 11 and 12 are schematics of a control circuit that controls the switching of a power converter to mitigate the effect of parasitic capacitance, in accordance with at least some examples.

FIG. 13 is a flowchart of a method of operation of a power converter to mitigate the effect of parasitic capacitance, in accordance with at least one example.

### DETAILED DESCRIPTION

Described herein is a clamp circuit that can clamp a VDS voltage (or a voltage across two current terminals) of a transistor by partially turning on the transistor responsive to a ringing/overvoltage event across the current terminals of the transistor. Examples of transistors are a complementary metal oxide semiconductor (CMOS) transistor, a high electron mobility transistor (HEMT) such as a gallium nitride (GaN) transistor, a laterally diffused metal oxide semiconductor (LDMOS), etc., that are configured to switch on/off causing ringing on the first current terminal or switching node from the power loop LC tank. The transistor can be a low-side switch of a buck converter, a main switch of a boost converter, a high-side switch of a buck converter, a rectifier transistor of a boost converter, or any other transistor.

In at least one example, a pull-up circuit and a pull-down circuit are coupled to a transistor control terminal of the transistor to switch on/off the transistor, and the clamp circuit can be part of the pull-down circuit. The pull-up circuit and the pull-down circuit are controlled by a driver circuit, which receives a modulated signal (e.g., a pulse width modulated signal, or a frequency modulated signal), to switch on/off the transistor. Responsive to the modulated signal having a first state (e.g., on-state), the driver circuit can enable the pull-up circuit and disable the pull-down circuit to pull up the voltage of the transistor control terminal to a high voltage (e.g., defined by a supply voltage of the pull-up circuit and/or the driver circuit) to fully enable the transistor, which can be a low-side switch. Another driver circuit may disable the other transistor (e.g., high-side switch) of the power converter responsive to the modulated signal having the first state. Also, responsive to the modulated signal having a second state (e.g., off-state), the driver circuit can disable the pull-up circuit and enable the pull-down circuit to pull down the voltage of the transistor control terminal to a low voltage (e.g., defined by a voltage at the source of the transistor), and the other transistor of the power converter may be enabled.

The pull-down circuit has a first pull-down sub-circuit and a second pull-down sub-circuit, where the first pull-down sub-circuit has a lower on-resistance (and provides a stronger pull-down path) than the second pull-down sub-circuit. During the switching of the power converter, the commutation of current may induce voltage ringing on a power rail or switching node of the power converter due to parasitic inductance and capacitance (e.g., at the power rail, switching node, and the ground terminal) of the power converter. The clamp circuit can enable the first pull-down sub-circuit and the second pull-down sub-circuit responsive to the switching of the power converter (e.g., responsive to a state of a control signal indicating that the transistor is to be disabled). Also, responsive to detecting a ringing event (or an overvoltage event) across the current terminals, the clamp circuit can disable the first pull-down sub-circuit, while the second pull-down sub-circuit remains enabled. A voltage transition event (dv/dt) that precedes the ringing event can cause a strong transient current to flow through the parasitic capacitance (e.g., gate-drain capacitance) of the transistor and the second pull-down sub-circuit and generate a voltage that can weakly enable the transistor (e.g., by setting the transistor control terminal to a voltage lower than the high voltage provided by the pull-up circuit). The weakly-enabled transistor can discharge the power rail/switching node to reduce the voltage ringing as well as the voltage stress on the transistor. Accordingly, the transistor is operated as a snubber. On the other hand, if the ringing event is not detected, or the voltage at the power rail/switching node caused by the ringing event is below a threshold, both the first and second pull-down sub-circuits can remain enabled to disable the transistor.

After the ringing has settled and the power rail/switching node voltage reaches a steady state, very little current (or no current) flows through the second pull-down sub-circuit, and the voltage across the second pull-down sub-circuit may be below the threshold of the transistor, therefore the transistor can be disabled. In some examples, responsive to detecting that the voltage across the transistor falls below a threshold, which indicates that the ringing has been mitigated, the clamp circuit may also enable the first pull-down sub-circuit to disable the transistor, which can reduce power loss caused by concurrently enabling both transistors (e.g., low-side and high-side switches) of the power converter.

In some examples, the detection of mitigation of ringing can be performed by a comparator that compares the voltage at the power rail/switching node with a reference voltage. The reference voltage can be provided by a reference generator that can adjust the reference voltage based on temperature and threshold voltage (VT) of the transistor, so that the detection of ringing being mitigated can consider the temperature and process variations and can be more robust.

By configuring the transistor to behave as a snubber or clamp, a separate clamp device is not needed thereby reducing die area (e.g., by 60%) compared to an example where high voltage active components are used in triggering or clamping the overshoot. In addition to protecting the transistor from voltage stress, the robustness of the voltage clamping, as well as the reduction of power loss caused by the voltage clamping, can be facilitated by comparing the voltage at the power rail/switching node with a reference voltage that tracks the temperature and process variations. Such arrangements can improve the robustness in distinguishing between a strong overvoltage event (that can degrade reliability of the transistor) and transients or a minor overvoltage event (that do not degrade reliability of the transistor), so that the clamp circuit can be controlled in a most robust manner to improve the reliability of the transistor while reducing power loss caused by the voltage clamp operation.

In some examples where the power converter is a buck converter, and the transistor is a low-side switch coupled between the switching node/terminal and the ground, the enabling of the pull-up circuit (and the transistor), responsive to the modulated signal having the on-state, can be delayed to enable transfer of charge stored in the parasitic capacitance at the switching node to the load. A control circuit coupled to the pull-up and the pull-down circuits of the transistor can sense the voltage transition rate at the switching node, which can indicate the inductor current as well as the load current. A high voltage transition rate can indicate that the parasitic capacitance is being discharged to supply a load current. Responsive to detecting a high voltage transition rate (e.g., the transition rate being higher than a threshold), the control circuit can delay enabling the transistor (the low-side switch) to enable the charge transfer from the parasitic capacitance to the load to continue. On the other hand, if a low voltage transition rate is detected, or the switch node voltage is at the ground voltage, both of which can indicate that the discharge is complete and/or the load current is small (or zero), the control circuit can enable the low-side switch to avoid excessive deadtime. Both arrangements can improve the efficiency of the power converter.

While various examples are illustrated for an n-type transistor configured as a low-side switch, the examples are applicable to other transistor configurations as discussed herein. For instance, the clamp circuit and operation can also be applied to an n-type transistor configured as a high side switch which is coupled in series with a low side switch. The examples are also applicable to a p-type transistor by appropriately complementing the logic discussed herein for an n-type transistor to apply for a p-type transistor.

In the drawings, like reference numerals refer to like elements throughout, and the various features are not necessarily drawn to scale. Here, the same reference numbers or other reference designators are used in the drawings to designate the same or similar (either by function and/or structure) features.

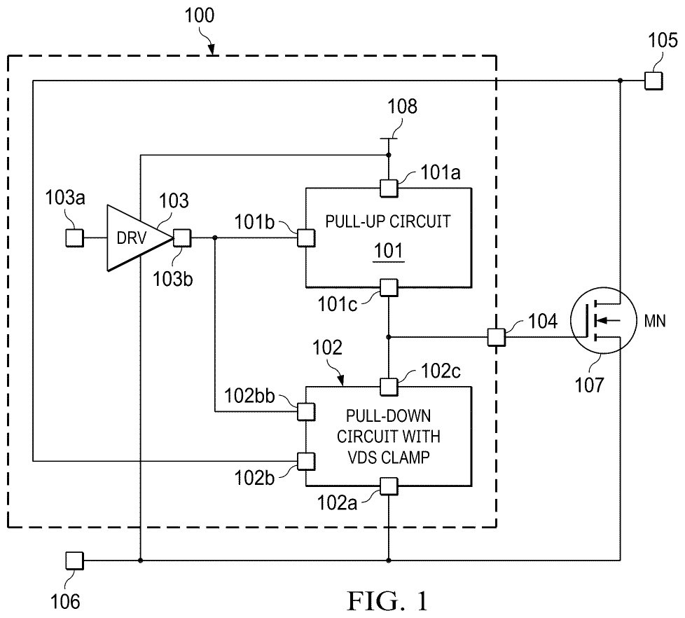

FIGS. 1-3 are schematics illustrating a control circuit 100 for a transistor MN 107, in accordance with at least some examples. Transistor MN 107 is coupled between first current terminal 105 and second current terminal 106. In at least one example, control circuit 100 comprises a pull-up circuit 101, a pull-down circuit 102 with a VDS clamp mechanism, and a driver 103. Driver 103 receives a modulated signal (e.g., a pulse width modulation signal and/or a frequency modulation signal) at a driver input 103a and provides an output at a driver output 103b that controls the logic level of a transistor control terminal 104 via pull-up circuit 101 and pull-down circuit 102.

Referring to FIG. 1, pull-up circuit 101 includes a pull-up bias 101a, a pull-up control input 101b, and a pull-up output 101c, where pull-up bias 101a is coupled to a supply rail 108, pull-up control input 101b is coupled to driver output 103b, and pull-up output 101c is coupled to transistor control terminal 104. Pull-up circuit 101 includes a switch (e.g., a transistor) coupled between pull-up bias 101a and pull-up output 101c. The switch can connect or disconnect between pull-up bias 101a and pull-up output 101c responsive to a state of pull-up control input 101b.

In at least one example, pull-down circuit 102 includes a pull-down bias 102a, a first pull-down control input 102b, a second pull-down control input 102bb, and a pull-down output 102c, where pull-down bias 102a is coupled to second current terminal 106, first pull-down control input 102b is coupled to first current terminal 105, second pull-down control input 102bb is coupled to driver output 103b, and pull-down output 102c is coupled to transistor control terminal 104. As to be described below, pull-down circuit 102 includes multiple switches/devices coupled between pull-down output 102c and pull-down bias 102a. The switches/devices can connect or disconnect between pull-down output 102c and pull-down bias 102a, responsive to a state of second pull-down control input 102bb. Also, responsive to a state of first pull-down control input 102b, which can indicate a voltage transition preceding the ringing event at first current terminal 105, the switches/devices can also provide a voltage at pull-down output 102c relative to pull-down bias 102a to weakly turn on transistor MN 107 to discharge first current terminal 105, thereby providing a clamp mechanism to clamp/mitigate a ringing event at first current terminal 105.

Transistor control terminal 104 is coupled to a gate of transistor MN 107, where a drain terminal of transistor MN 107 is coupled to first current terminal 105 and a source terminal of transistor MN 107 is coupled to second current terminal 106. In at least one example, transistor MN 107 is an n-type transistor that can be one of a CMOS transistor, a HEMT (e.g., a GaN transistor), or a LDMOS transistor. In the case where transistor MN 107 is a low side switch of a DC-DC converter or half bridge, first current terminal 105 is a switching node while second current terminal 106 is a ground rail. In the case where transistor MN 107 is a high side switch of a DC-DC converter or half bridge, first current terminal 105 is a power supply terminal while second current terminal 106 is the switching terminal.

In at least one example, responsive to the logic value of driver output 103b having a first state (e.g., a logical one), pull-up circuit 101 can be enabled to connect transistor control terminal 104 to supply rail 108 to charge transistor control terminal 104 to a voltage of supply rail 108 and turn on transistor MN 107. Also, pull-down circuit 102 can be disabled, resulting in a high-impedance path between transistor control terminal 104 and second current terminal 106. In at least one example, responsive to the logic value of driver output 103b having a second state (e.g., a logical zero), pull-up circuit 101 can be disabled, resulting in a high-impedance path between transistor control terminal 104 and supply rail 108. Also, pull-down circuit 102 can connect transistor control terminal 104 to second current terminal 106 to discharge transistor control terminal 104 to a voltage of second current terminal 106 and turn off transistor MN 107. As described herein, responsive to a voltage transition that indicates a voltage ringing event is about to occur at second current terminal 106 (e.g., a high VDS voltage of MN 107), pull-down circuit 102 can provide a voltage of transistor control terminal 104 to a voltage below the voltage of supply rail 108 to weakly turn on MN 107 to discharge first current terminal 104 and mitigate the voltage ringing, to reduce the voltage stress on transistor MN 107 and improve reliability.

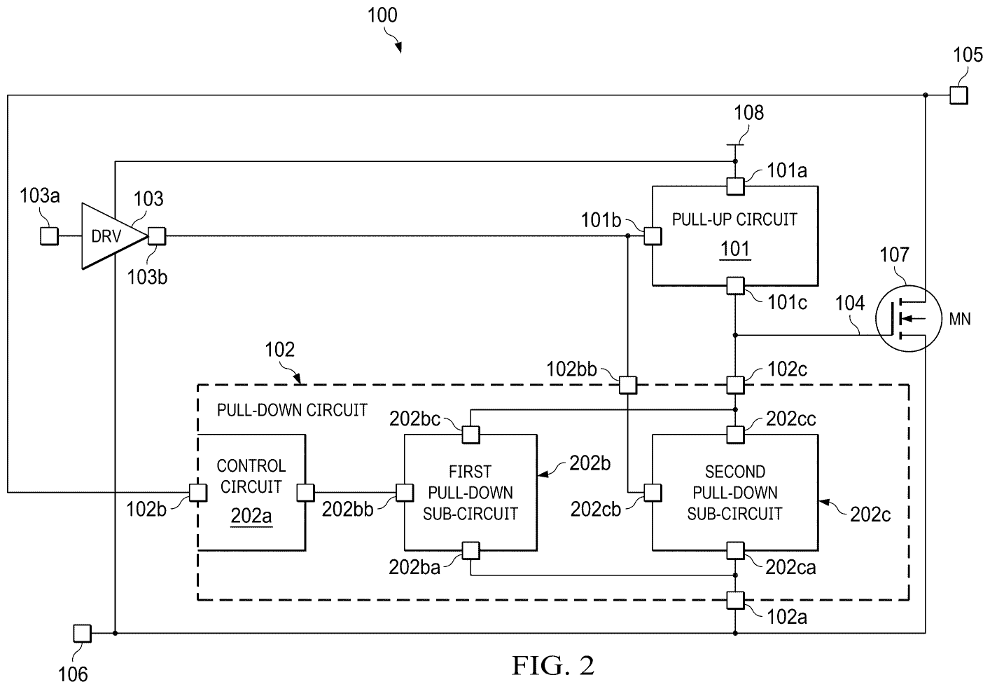

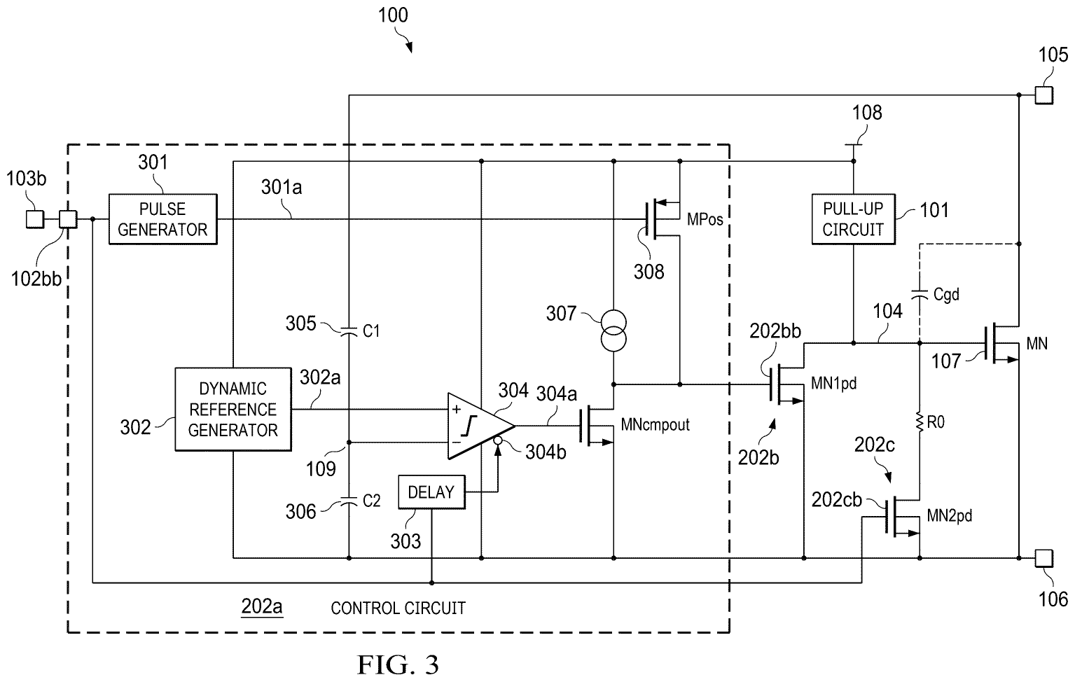

Referring to FIG. 2, in at least one example, pull-down circuit 102 includes a control circuit 202a, a first pull-down sub-circuit 202b, and a second pull-down sub-circuit 202c. Also, referring to FIG. 3, in at least one example, control circuit 202a comprises a dynamic reference generator 302, a delay circuit 303, a comparator 304, a voltage divider including a first capacitor C1 305 and a second capacitor C2 306 coupled in series, a current source 307, a third switch MPos, and transistor MNcmpout. In at least one example, control circuit 202a initially enables first pull-down sub-circuit 202b, responsive to the logic value of driver output 103b having a second state, to disable transistor MN 107. Control circuit 202a also monitors for ringing on first current terminal 105 relative to an adjustable threshold/reference. If the voltage on first current terminal 105 exceeds the reference, control circuit 202a can disable first pull-down sub-circuit 202b.

Also, responsive to the logic value of driver output 103b having a second state, control circuit 202a can enable second pull-down sub-circuit 202c. As described above, if the voltage on first current terminal 105 exceeds the reference, control circuit 202a can disable first pull-down sub-circuit 202b. With first pull-down sub-circuit 202b disabled and second pull-down sub-circuit 202c enabled, a voltage ringing on first current terminal 105 can cause a current to flow through a parasitic capacitance of transistor MN 107 (e.g., gate-drain capacitance), second pull-down sub-circuit 202c into second current terminal 106, and develop a voltage at transistor control terminal 104. The voltage is lower than a high voltage provided by pull-up circuit 101 when enabled (e.g., a voltage at supply rail 108) but is high enough to weakly enable transistor MN 107. The weakly-enabled transistor MN 107 can discharge first current terminal 105 and MN 107 mitigate the voltage ringing and overshoot in the signal on first current terminal 105.

Referring to FIG. 3, in at least one example, dynamic reference generator 302, which is coupled between supply rail 108 and second current terminal 106, generates an adjustable reference on reference output 302a which is input to a first input terminal of comparator 304. In at least one example, dynamic reference generator 302 changes the adjustable reference based on process, voltage, and/or temperature of a replica transistor MN 107, such that the reference tracks the process, voltage, and/or temperature of MN 107. Such arrangements enable more robust detection of voltage ringing across MN 107 over various operation conditions of MN 107.

Comparator 304 is coupled between supply rail 108 and second current terminal 106, where supply rail 108 provides a low power supply voltage (e.g., compared with a maximum voltage at first current terminal 105) for low voltage transistors, such as those used by dynamic reference generator 302 and comparator 304. Since first current terminal 105 may experience a high voltage that can damage integrity of low voltage transistors, such as those of comparator 304, a second input terminal of comparator 304 receives a divided version of signal on first current terminal 105 via the divider, where the division can be set by the capacitive ratio between capacitors 305 and 306. Monitoring the divided version of the signal also allows the reference provided by dynamic reference generator 302 to be at a relatively low voltage (compared with the voltage at first current terminal 105), which allows dynamic reference generator 302 to operate from supply rail 108, and a separate high voltage power supply is not needed for dynamic reference generator 302.

Comparator 304 monitors a divided voltage 109 on first current terminal 105 relative to the adjustable reference on reference output 302a, where the voltage on the first current terminal 105 includes the AC noise manifesting as ringing or overshoot. This AC noise is captured by the high-pass filter that divides the voltage on first current terminal 105 and provides divided voltage 109 with high frequency AC ringing to the second input terminal of comparator 304. Comparator 304 compares divided voltage 109 against the adjustable reference on reference output 302a and generates compOut 304a as output that indicates whether divided voltage 109 is above or below the adjustable reference. Transistor MNcmpout is controlled by compOut 304a. In at least one example, comparator 304 includes an enable input 304b which receives an enable signal based on driver output 103b. The enable signal is delayed by delay circuit 303 to enable comparator 304 just before the voltage on first current terminal 105 begins to ring or overshoot, to reduce power consumption by comparator 304. In at least one example, when the voltage on first current terminal 105 is low (e.g., at the voltage on second current terminal 106), the enable signal causes comparator 304 to turn off since no ringing or overshoot of concern is desired to be monitored thereby saving power.

In at least one example, current source 307 is coupled in series with transistor MNcmpout and provides a current load to transistor MNcmpout. In some examples, current source 307 can also supply current to charge first switch control terminal 202bb (e.g., after it has been discharged by transistor MNcmpout) to fully enable first pull-down sub-circuit 202b, after the ringing settles. In at least one example, pulse generator 301 generates a short one-time pulse to turn on a third switch 308 responsive to driving output 103b having the second state (e.g., indicating that MN 107 is to be disabled). Third switch 308 may comprise a p-type transistor MPos where a gate terminal of transistor MPos is connected to third switch control terminal 301a, a source terminal of transistor MPos is coupled to supply rail 108, and a drain terminal of transistor MPos is coupled to first switch control terminal 202bb. In at least one example, the pulse on third switch control terminal 301a causes transistor MPos to charge first switch control terminal 202bb, which in turn turns on first pull-down sub-circuit 202b to bring down the voltage of transistor control terminal 104 to the voltage of second current terminal 106, to disable transistor MN 107. In at least one example, pulse generator 301 generates a new short one-time pulse after the voltage on the first current terminal 105 discharges to a steady low voltage level. After the pulse has elapsed, the voltage of first switch control terminal 202bb can be weakly maintained by current source 307, unless transistor MNcmpout is enabled and first switch control terminal 2022b is discharged.

In at least one example, first pull-down sub-circuit 202b includes a first pull-down bias 202ba coupled to pull-down bias 102a, a first control terminal 202bb which is coupled to an output of control circuit 202a, and a first pull-down output 202bc coupled to pull-down output 102c. In at least one example, first pull-down sub-circuit 202b comprises an n-type transistor MN1pd with a gate terminal coupled to first switch control terminal 202bb, a source terminal coupled to second current terminal 106, and a drain terminal coupled to transistor control terminal 104. In at least one example, second pull-down sub-circuit 202c includes a second pull-down bias 202ca coupled to pull-down bias 102a, a second control terminal 202cb which is coupled to second pull-down control input 102bb, and a second pull-down output 202cc coupled to pull-down output 102c. In at least one example, second pull-down sub-circuit 202c comprises an n-type transistor MN2pd coupled in series with a resistor R0, which in turn is connected to transistor control terminal 104. In at least one example, a gate terminal of transistor MN2pd is coupled to driver output 103b, a source terminal of transistor MNpd is coupled to second current terminal 106, and a drain terminal of transistor MN2pd is coupled to resistor R0. In various examples, transistor MN1pd has a larger width than transistor MN2pd. Transistor MN2pd coupled in series with resistor R0 which, combined with the smaller size (and higher impedance) of transistor MN2pd, provides a relatively high impedance pull-down path from transistor control terminal 104 to second current terminal 106. In some examples, the resistance of R0 dominates (and largely sets) the overall impedance of the pull-down path. Also, transistor MN1pd provides a relatively low resistance path from transistor control terminal 104 to second current terminal 106 due to, for example, absence of resistor R0 and transistor MN2pd having a smaller width than transistor MN1pd.

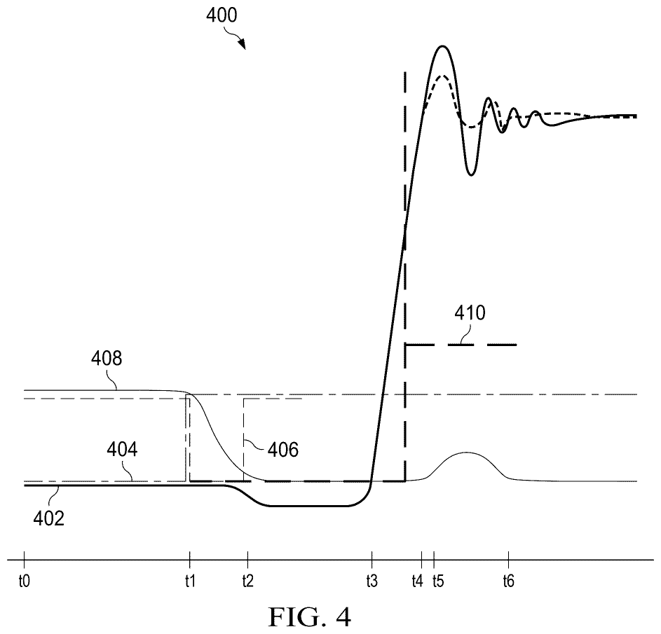

FIG. 4 is a plot 400 illustrating examples of operation of the clamp circuit and its impact on reducing ringing, in accordance with at least one example. Plot 400 includes graphs 402, 404, 406, 408, and 410. Graph 402 illustrates an example variation of a voltage at first current terminal 105 with time. Graph 404 illustrates an example variation of a voltage at second control terminal 202cb (the control of second pull-down sub-circuit 202c). Graph 406 illustrates an example variation of a voltage at third switch control terminal 301a (which sets a state of first switch control terminal 202bb). Graph 408 illustrates an example variation of a voltage at transistor control terminal 104. Graph 410 illustrates an example variation of a voltage at compOut 304a (the output of comparator 304).

In at least one example, at time to in a first phase of a switching cycle, pull-up circuit 101 is enabled to turn on transistor MN 107 by pulling the voltage on transistor control terminal 104 to the voltage of a supply rail 108 based on driver output 103b. For instance, during a first switching cycle (or first phase) when driver 103is to pull down the voltage on first current terminal 105 (e.g., a switching node of a buck converter), pull-up circuit 101 pulls up the voltage on transistor control terminal 104. In this example, transistor MN 107 is a low side switch. A high voltage on transistor control terminal 104, such that the gate source voltage is above a threshold voltage (Vt) of transistor MN 107, turns on transistor MN 107 to discharge first current terminal 105 (e.g., the switching node). Transistor MN 107 is turned on if the voltage on transistor control terminal 104 exceeds Vt, and the on-resistance of transistor MN 107 increases with the voltage. Likewise, a low voltage on transistor control terminal 104, such that the gate source voltage is below the threshold voltage of transistor MN 107, turns off transistor MN 107.

In at least one example, at time t1 in a second phase of the switching cycle, pull-up circuit 101 is disabled, and transistor MN2pd of second pull-down sub-circuit 202c is enabled, responsive to a state change of driver output 103b. Transistor MN2pd can remain turned on for the rest of the second phase of the switching cycle. At time t1, transistor MN1pd of first pull-down sub-circuit 202b is also enabled by pulse generator 301 responsive to driver output 103b, but only for a short duration (between t1 and t2), to charge and set a default/initial state of first switch control terminal 202bb, which is to enable transistor MN1pd to pull down the voltage of transistor control terminal 104.

Specifically, pulse generator 301 generates a pulse on third switch control terminal 301a, which controls third switch 308 by turning on p-type transistor MPos, responsive to a state change of driver output 103b that indicates start of the second phase of the switching cycle. After the pulse has elapsed (after time t2), the transistor MPos is disabled, which allows transistor MNcmpout (enabled by comparator 304) to pull down the voltage of first switch control terminal 202bb and disable first pull-down sub-circuit 202b if excessive voltage ringing at first current terminal 105 is detected by comparator 304. This in turn allows second pull-down sub-circuit 202c to generate a voltage at transistor control terminal 104 (from a transient current through the Cgd capacitance of transistor MN 107 caused by the voltage transition that precedes the voltage ringing) to weakly turn on transistor MN 107 to mitigate the voltage ringing. On the other hand, if excessive voltage ringing is not detected, or the voltage at first current terminal 105 reaches steady state, comparator 304 can disable transistor MNcmpout, and, current source 307 can maintain first switch control terminal 202bb in the default/initial state, and transistor MN 107 can remain turned off throughout the second phase of the switching cycle.

In at least one example, at time t3 and onwards till time t6, the high frequency voltage on first current terminal 105 is monitored by comparator 304 against the adjustable threshold voltage on reference output 302a as the voltage on first current terminal 105 is being pulled up (e.g., by the high side switch). If comparator 304 determines that divided voltage 109 is above the adjustable threshold, which can indicate that an excessive overshoot or an excessive ringing is about to occur on first current terminal 105, as indicated between times t4 and t5. Such arrangements allows disabling of first pull-down sub-circuit 202b when the voltage ringing has not yet exceeded the threshold, so that the transient current caused by the voltage transition preceding the ringing can flow through second pull-down sub-circuit 202c, instead of the disabled first pull-down sub-circuit 202b, to generate the weak turn-on voltage for transistor control terminal 104.

Specifically, at time t4, upon determining that divided voltage 109 is above the adjustable threshold, compOut 304a is asserted, which in turn turns on transistor MNcmpout. When transistor MNcmpout turns on, first switch control terminal 202bb is discharged, which turns off transistor MN1pd of first pull-down sub-circuit 202b and prevent transistor control terminal 104 from discharging via first pull-down sub-circuit 202b. Because first pull-down sub-circuit 202b is disabled, transient current can flow through the parasitic capacitance Cgd and second pull-down sub-circuit 202c and generate a voltage across the high impedance path (provided by resistor R0 and transistor MN2pd) to weakly turn on transistor MN 107.

In at least one example, the Cgd capacitance of transistor MN 107 increases the voltage of transistor control terminal 104 just enough to weakly turn on transistor MN 107 between times t5 and t6. As discussed herein, Cgd coupling exists for transistor MN 107 between first current terminal 105 and transistor control terminal 104. A voltage transition event at first current terminal 105, preceding the voltage ringing event, causes a transient current to flow across the Cgd and through the high impedance resistance path of second pull-down sub-circuit 202c and generate a voltage bump between times t5 and t6.

Transient current caused by the ringing flows through the Cgd coupling and is directed to second current terminal 106 via the high impedance path provided by the series coupled resistor R0 and transistor MN2pd, and creates a voltage at transistor control terminal 104 that is lower than the voltage of supply rail 108 but is high enough to weakly turn on transistor MN 107. By weakly turning on transistor MN 107, transistor MN 107 is configured as a snubber or clamp to discharge first current terminal 105, which can dampen or reduce the overshoot on first current terminal 105 (e.g., the switching node).

On the other hand, if the voltage input to comparator 304 is below the adjustable threshold (e.g., after time t6 as shown in FIG. 4, there is no more ringing as the voltage on first current terminal 105 settles), which can indicate that ringing/overshoot is within acceptable levels (e.g., within a target level that does not degrade the reliability of transistor MN 107, or the degradation is within an acceptable level), or the voltage at first current terminal 105 reaches a steady state, compOut 304a from comparator 304 can be in a state to disable transistor MNcmpout and first pull-down sub-circuit 202b. In some examples, transient current can stop flowing into second pull-down sub-circuit 202c due to, for example, a static voltage across the Cgd capacitance (e.g., due to reduced voltage ringing or the voltage at first current terminal 105 reaching a steady state), and the voltage across the high impedance path of second pull-down sub-circuit 202c is below the threshold voltage of transistor MN 107. Accordingly, transistor MN 107 can be disabled. In some examples, current source 307 can also charge up first switching control terminal 202bb and enable transistor MN1pd (and first pull-down sub-circuit 202b), which in turn can also disable transistor MN 107.

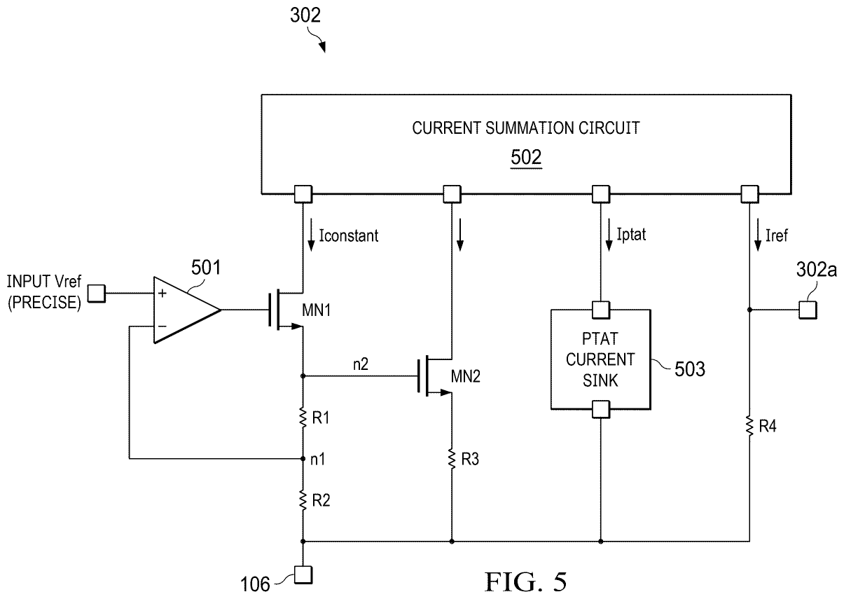

FIG. 5 is a schematic illustrating dynamic reference generator 302, in accordance with at least one example. In at least one example, dynamic reference generator 302 comprises a bias generation circuit that receives a precise input voltage reference Vref, such as a bandgap reference and generates a bias output using an amplifier 501 configured in feedback. The bias output is received by a gate of an n-type transistor MN1. Transistor MN1 is further coupled to series coupled resistors R1 and R2, where resistor R2 is coupled to second current terminal 106. A common node n1 between resistors R1 and R2 is fed back to amplifier 501 as input. Amplifier 501 maintains the bias output and thus the voltage on node n2 by biasing transistor MN1 to cause voltages between the voltage on node n1 and the precise input reference (Vref) to be substantially equal. For instance, when Vref is 1.2V, amplifier 501 biases transistor MN1 such that the voltage on node n1 is also 1.2V. Voltage on node n2 is a constant and the resistors R1 and R2 have constant resistance over temperature resulting in constant current through transistor MN1. The bias generation circuit can be configured as a constant current generator, in which the current that flows in transistor MN1, labelled Iconstant, is set by a ratio between Vref and R2 resistance. The Iconstant current is also mirrored/replicated by circuit 502.

In at least one example, an n-type transistor MN2 is biased by a voltage on node n2, where the voltage on node n2 is a function of voltage on node n1 (e.g., x*n1). Transistor MN2 receives a second current from current summation circuit 502. The current sunk by transistor MN2 is inversely proportional to the Vth of transistor MN2, which can be a replica of transistor MN 107. Transistor MN2 is further coupled in series with resistor R3, which is coupled to second current terminal 106. The current through transistor MN2 is also mirrored/replicated by circuit 502.

In at least one example, dynamic reference generator 302 further includes a proportional to absolute temperature (PTAT) current sink 503 coupled between current summation circuit 502 and second current terminal 106. The current through PAT current sink 503, labelled Iptat, is also mirrored/replicated by circuit 502.

In at least one example, an output branch that provides reference output 302a is coupled between current mirror and summation circuits 502 and second current terminal 106, where the output branch includes a resistor R4. Current mirror and summation circuits 502 can generate a reference current Iref based on summing replicas of constant current Iconstant through resistor R1, current Iptat through PTAT current sink 503, and the current through transistor MN2. In at least one example, current summation circuit 502 multiplies different weights to constant current Iconstant, current Iptat, and the current through transistor MN2 to achieve the desired reference current Iref. As temperature rises, the current through PTAT current sink 503 also increases, and vice versa. The current through transistor MN2 changes with process, temperature, and/or voltage as the threshold voltage of transistor MN2 changes with process, temperature, and/or voltage. The current through transistor MN2 is inversely proportional to the threshold voltage of transistor MN2. For instance, as the threshold voltage of transistor MN2 becomes smaller, the current through transistor MN2 and R3 becomes larger, and the reference voltage at reference output 302a also increases.

For a certain process, temperature, and/or reference voltage condition, the adjustable reference on reference output 302a is constant. As process and temperature change for transistor MN2, the threshold voltage for transistor MN2 also changes. These changes are proportionally captured in the adjustable reference. For instance, if the threshold voltage of transistor MN2 increases, the adjustable reference on reference output 302a lowers. Likewise, if the threshold voltage of transistor MN2 decreases, the adjustable reference voltage on reference output 302a rises.

With such arrangements, the reference voltage can track the process, temperature and the reference voltage condition of MN 107, which makes the detection (or non-detection) of voltage overshoot, and the enabling or disabling of the clamp circuit, more robust across different process, temperature, and reference voltage conditions.

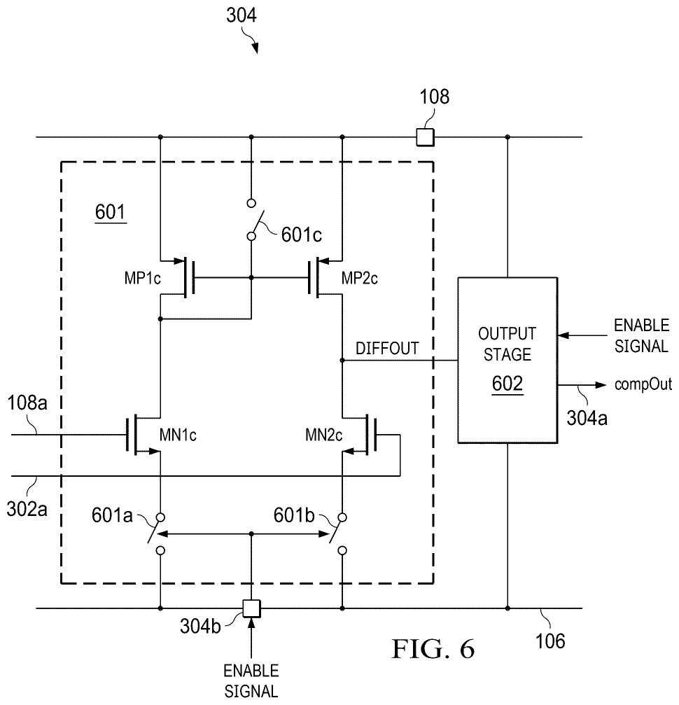

FIG. 6 is a schematic illustrating a comparator 304, in accordance with at least one example. In at least one example, comparator 304 comprises a difference stage 601 and an output stage 602 coupled between supply rail 108 and second current terminal 106. In at least one example, difference stage 601 comprises n-type common source input transistors MN1c and MN2c that receive divided voltage 109 and reference output 302a, respectively. In at least one example, the input transistors MN1c and MN2c are coupled to a current mirror comprising p-type transistors MP1c and MP2c, where transistor MP1c is a diode-connected transistor. In at least one example, input transistors MN1c and MN2c are coupled to second current terminal 106 via switches 601a and 601b, respectively. In at least one example, a switch 601c is coupled to gate terminals of p-type transistors MP1c and MP2c. Switches 601a, 601b, and 601c are controlled by enable signal. In at least one example, a current source is not coupled to the sources of transistors MN1c and MN2c because the current source can be current limiting. In at least one example, digitally controlled switches 601a and 601b are used instead of the current source to increase the speed of operation of difference stage 601 (e.g., higher slew rate at the output diffout).

As discussed herein, when comparator 304 is not needed outside of the expected ringing window on the voltage on first current terminal 105, it can be disabled to save power using the enable signal and switches 601a, 601b, and 601c. Depending on whether divided voltage 109 is above or below the adjustable reference on reference output 302a, the output diffout of difference stage 601 will either rise to supply rail 108 or fall to second current terminal 106. The output diffout of difference stage 601 is then amplified by an output stage 602 to generate an amplified output compOut 304a. In at least one example, output stage 602 comprises a common drain stage. In at least one example, output stage 602 can also be enabled and disabled using the enable signal.

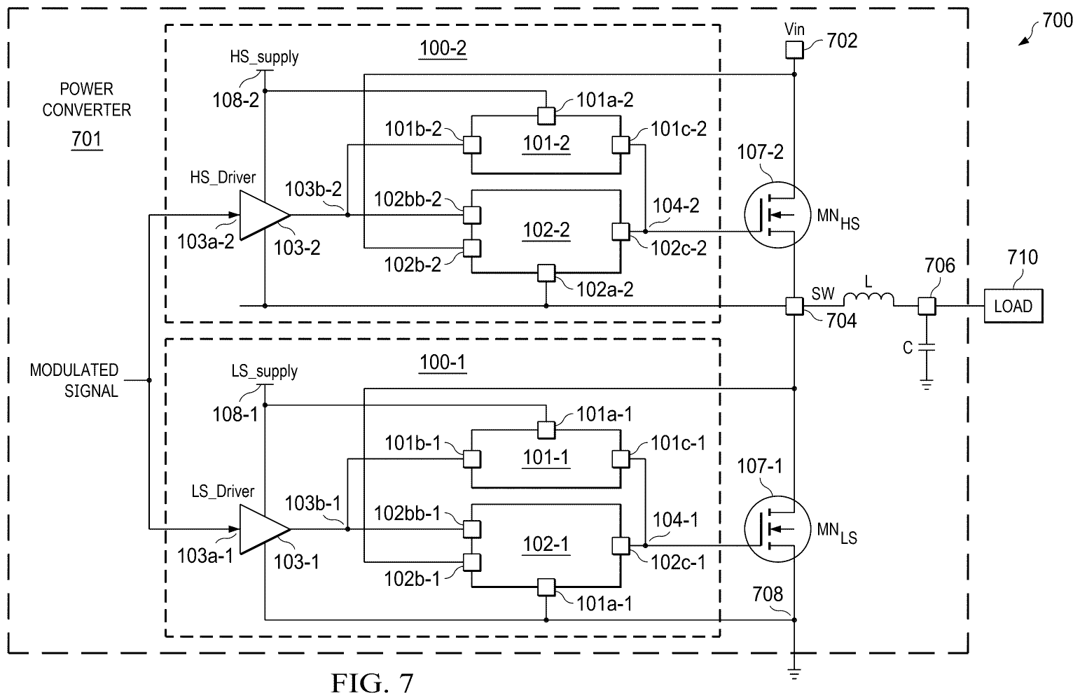

FIG. 7 is a schematic illustrating a system 700 including a boost converter, in accordance with at least one example. System 700 comprises power converter 701 illustrated as a buck converter. System 700 comprises inductor L, output capacitor C, and a load 710. Load 710 can be any suitable load, such as a processor, fan, motor, etc. Buck converter 701 includes a high side switch MN_{HS} 107-2 coupled between a power input 702 and a switch node/terminal 704, and a low side switch MN_{LS} 107-1 coupled between switch node 704 and ground. Inductor Lis coupled between switch node 704 and a power output 706, which is coupled to output capacitor C and load 710.

In at least one example, two instances of control circuit 100 are used in power converter 701. For example, a first instance of control circuit 100-1, including pull-up circuit 101-1 and pull-down circuit 102-1, is configured to control low side switch MN_{LS} 107-1. Also, a second instance of control circuit 100-2, including pull-up circuit 101-2 and pull-down circuit 102-2, is configured to control high side switch MN_{HS} 107-2.

Low side switch MN_{LS} 107-1 is coupled between switch node 704 and a ground terminal 708. In at least one example, control circuit 100-1 comprises a pull-up circuit 101-1, a pull-down circuit 102-1 with a VDS clamp mechanism, and a driver 103-1. Driver 103-1 receives a modulated signal (e.g., a pulse width modulation signal and/or a frequency modulation signal) at a driver input 103a-1 and provides an output at a driver output 103b-1 that controls the logic level of a transistor control terminal 104-1 via pull-up circuit 101-1 and pull-down circuit 102-1.

In at least one example, pull-up circuit 101-1 includes a pull-up bias 101a-1, a pull-up control input 101b-1, and a pull-up output 101c-1, where pull-up bias 101a-1 is coupled to a supply rail 108-1, pull-up control input 101b-1 is coupled to driver output 103b-1, and pull-up output 101c-1 is coupled to transistor control terminal 104-1. Pull-up circuit 101-1 includes a switch (e.g., a transistor) coupled between pull-up bias 101a-1 and pull-up output 101c-1. The switch can connect or disconnect between pull-up bias 101a-1 and pull-up output 101c-1 responsive to a state of pull-up control input 101b-1.

In at least one example, pull-down circuit 102-1 includes a pull-down bias 102a-1, a first pull-down control input 102b-1, a second pull-down control input 102bb-1, and a pull-down output 102c-1, where pull-down bias 102a-1 is coupled to ground terminal 708, first pull-down control input 102b-1 is coupled to switch node 704, second pull-down control input 102bb-1 is coupled to driver output 103b-1, and pull-down output 102c-1 is coupled to transistor control terminal 104-1.

Transistor control terminal 104-1 is coupled to a gate of low side switch MN_{LS} 107-1, where a drain terminal of low side switch MN_{LS} 107-1 is coupled to switch node 704 and a source terminal of low side switch MN_{LS} 107-1 is coupled to ground terminal 708. In at least one example, low side switch MN_{LS} 107-1 is an n-type transistor that can be one of a CMOS transistor, a GaN transistor, or a LDMOS transistor.

In at least one example, responsive to the logic value of driver output 103b-1 having a first state (e.g., a logical one), pull-up circuit 101-1 can be enabled to connect transistor control terminal 104-1 to supply rail 108-1 to charge transistor control terminal 104-1 to a voltage of supply rail 108-1 and turn on low side switch MN_{LS} 107-1. Also, pull-down circuit 102-1 can be disabled, resulting in a high-impedance path between transistor control terminal 104-1 and ground terminal 708. In at least one example, responsive to the logic value of driver output 103b-1 having a second state (e.g., a logical zero), pull-up circuit 101-1 can be disabled, resulting in a high-impedance path between transistor control terminal 104-1 and supply rail 108-1. Also, pull-down circuit 102-1 can connect transistor control terminal 104-1 to ground terminal 708 to discharge transistor control terminal 104-1 to a ground voltage and turn off low side switch MN_{LS} 107-1. As described herein, pull-down circuit 102-1 includes a strong (and low impedance) pull-down path and a weak (and high impedance) pull-down path. Responsive to a voltage transition preceding a voltage ringing event (or an overvoltage event) across switch node 704 and ground terminal 708 (e.g., a high VDS voltage of low side switch MN_{LS} 107-1), pull-down circuit 102-1 can disable the strong pull-down path and enable the weak-pull down path to provide a voltage of transistor control terminal 104-1 below the voltage of supply rail 108-1 to weakly turn on low side switch MN_{LS} 107-1 to discharge switch node 704 and mitigate the voltage ringing, to reduce the voltage stress on low side switch MN_{LS} 107-1 and improve reliability.

High side switch MN_{HS} 107-2 is coupled between switch node 704 and power input 702. In at least one example, control circuit 100-2 comprises a pull-up circuit 101-2, a pull-down circuit 102-2 with a VDS clamp mechanism, and a driver 103-2. Driver 103-2 receives the modulated signal at a driver input 103a-2 and provides an output at a driver output 103b-2 that controls the logic level of a transistor control terminal 104-2 via pull-up circuit 101-2 and pull-down circuit 102-2.

In at least one example, pull-up circuit 101-2 includes a pull-up bias 101a-2, a pull-up control input 101b-2, and a pull-up output 101c-2, where pull-up bias 101a-2 is coupled to a supply rail 108-2, pull-up control input 101b-2 is coupled to driver output 103b-2, and pull-up output 101c-2 is coupled to transistor control terminal 104-2. Pull-up circuit 101-2 includes a switch (e.g., a transistor) coupled between pull-up bias 101a-2 and pull-up output 101c-2. The switch can connect or disconnect between pull-up bias 101a-2 and pull-up output 101c-2 responsive to a state of pull-up control input 101b-2.

In at least one example, pull-down circuit 102-2 includes a pull-down bias 102a-2, a first pull-down control input 102b-2, a second pull-down control input 102bb-2, and a pull-down output 102c-2, where pull-down bias 102a-2 is coupled to switch node 704, first pull-down control input 102b-2 is coupled to power input 702, second pull-down control input 102bb-2 is coupled to driver output 103b-2, and pull-down output 102c-2 is coupled to transistor control terminal 104-2. In at least one example, pull-down circuit 102-2 includes multiple switches/devices coupled between pull-down output 102c-2 and pull-down bias 102a-2.

Transistor control terminal 104-2 is coupled to a gate of high side switch MN_{HS} 107-2, where a drain terminal of high side switch MN_{HS} 107-2 is coupled to power input 702 and a source terminal of high side switch MN_{HS} 107-2 is coupled to switch node 704. In at least one example, high side switch MN_{HS} 107-2 is an n-type transistor that can be one of a CMOS transistor, a GaN transistor, or a LDMOS transistor.

In at least one example, responsive to the logic value of driver output 103b-2 having a first state (e.g., a logical one), pull-up circuit 101-2 can be enabled to connect transistor control terminal 104-2 to supply rail 108-2 to charge transistor control terminal 104-2 to a voltage of supply rail 108-2 and turn on high side switch MN_{HS} 107-2. Also, pull-down circuit 102-2 can be disabled, resulting in a high-impedance path between transistor control terminal 104-2 and switch node 704. In at least one example, responsive to the logic value of driver output 103b-2 having a second state (e.g., a logical zero), pull-up circuit 101-2 can be disabled, resulting in a high-impedance path between transistor control terminal 104-2 and supply rail 108-2. Also, pull-down circuit 102-2 can connect transistor control terminal 104-2 to switch node 704 to discharge transistor control terminal 104-2 and turn off high side switch MN_{HS} 107-2. Pull-down circuit 102-2 can provide a clamp mechanism similar to pull-down circuit 102-1 to mitigate ringing at power input 702, to reduce the voltage stress on high side switch MN_{HS} 107-2 and improve reliability.

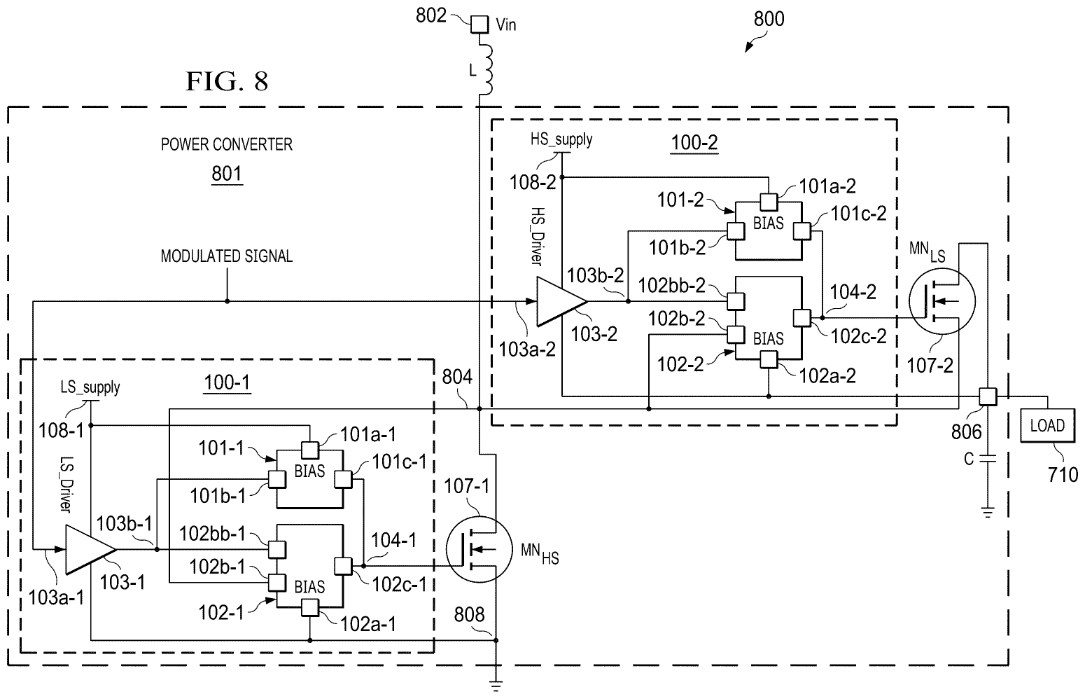

FIG. 8 is a schematic illustrating a system 800 including a boost converter, in accordance with at least one example. System 800 comprises power converter 801 illustrated as a boost converter. System 800 comprises inductor L, output capacitor C, and load 710 (e.g., processor, fan, motor). A boost converter 801 includes inductor L coupled between a power input 802 and a switch terminal/node 804, a low side switch MN_{LS} 107-1 coupled between switch node 804 and ground 808, and a high side switch MN_{HS} 107-2 coupled between switch node 804 and a power output 806, which is coupled to output capacitor C and load 710.

In at least one example, two instances of control circuit 100 are used in power converter 801. For example, a first instance of control circuit 100-1, including pull-up circuit 101-1 and pull-down circuit 102-1, is configured to control low side switch MN_{LS} 107-1 Also, a second instance of control circuit 100-2, including pull-up circuit 101-2 and pull-down circuit 102-2, is configured to control low side switch MN_{LS} 107-2. Pull-down circuit 102-1 has a sense input coupled to switch node 804 and includes examples of VDS clamp mechanism, such as those described in FIGS. 2-6, to clamp or snub ringing on switch node 804. Also, pull-down circuit 102-2 has a sense input coupled to power output 806 and includes examples of VDS clamp mechanism, such as those described in FIGS. 2-6, to clamp or snub ringing on power output 806.

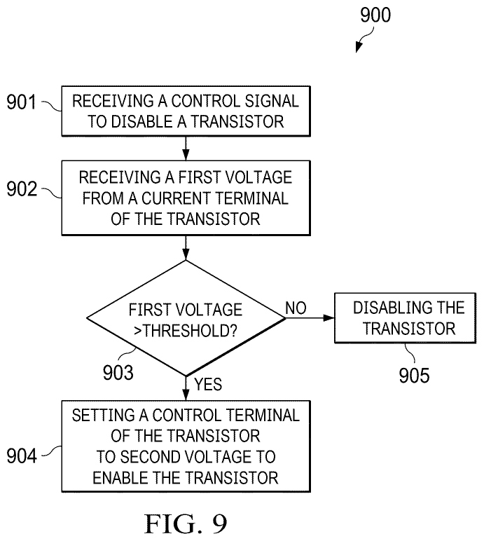

FIG. 9 is a flowchart 900 of a method of operation of the VDS clamp circuit, in accordance with at least one example. At least some of the operations of flowchart 900 are illustrated in plot 400 and can be performed by control circuit 100. At block 901, transistor control terminal 104 is discharged to second current terminal 106 which in turn disables transistor MN 107. In at least one example, pulse generator 301 generates a pulse on third switch control terminal 301a based on driver output 103b to turn on third switch 308. Third switch 308 when turned on, charges first switch control terminal 202bb, which in turn turns on transistor MN1pd of first pull-down sub-circuit 202b. Upon turning on transistor MN1pd, transistor control terminal discharges through transistor MN1pd, which in turn disables transistor MN 107.

At block 902, comparator 304 receives divided voltage 109 from first current terminal 105 of transistor MN 107. Divided voltage 109 is generated by a voltage divider having series coupled capacitors C1 305 and C2 306 that provide the AC component of voltage on first current terminal 105 as divided voltage 109.

A block 903, comparator 304 compares the divided voltage 109 with the adjustable voltage on reference output 302a. In at least one example, if the divided voltage 109 exceeds the adjustable voltage threshold, the process proceeds to block 904. At block 904, comparator 304 turns on transistor MNcmpout, which in turn disables transistor MN1pd. Transistor MN2pd receives a voltage from driver output 103b and provides a high impedance path from transistor control terminal 104 to second current terminal 106 of transistor MN 107. Transient current caused by a voltage transition at first current terminal 105, preceding the voltage ringing event, flows through the gate to drain parasitic capacitive coupling and is directed to second current terminal 106 via the high impedance path provided by the series coupled resistor R0 and transistor MN2pd. By weakly turning on transistor MN 107, transistor MN 107 is configured as a snubber or clamp to dampen or reduce the overshoot on the switching node.

If the voltage input to comparator 304 is below the adjustable threshold, the process proceeds to block 905, which means that ringing is within acceptable levels and compOut 304a from comparator 304 disables transistor MNcmpout, or the voltage at first current terminal 105 is in a steady state, all of which lead to reduced or no voltage transition at first current terminal 105. In some examples, MN1pd can remain disabled. A weak transient current (or no transient current) may flow through the high impedance path of resistor R0 and transistor MN2pd due to the reduced voltage transition, which brings down the voltage at transistor control terminal 104 and disables transistor MN 107. In some examples, current source 307 may also charge up first switching control terminal 202bb and enables transistor MN1pd, which can also bring down the voltage at transistor control terminal 104 and disables transistor MN 107. A discharged transistor control terminal 104 disables transistor MN 107.

Referring again to FIG. 7, in a first phase of a switching cycle where high side switch MN_{HS} 107-2 is turned on and low side switch MN_{LS} 107-1 is turned off, switch node 704 can be charged up by the power source connected to power input 702 (providing the input voltage Vin), and charge can be stored in the parasitic capacitances at switch node 704. It is advantageous to maximize the transfer of at least some of the charge stored in the parasitic capacitances at switch node 704 to the load, rather than draining the charge to ground, to improve power efficiency. Accordingly, during the second phase of the switching cycle where high side switch MN_{HS} 107-2 is turned off, the turning on of low side switch MN_{LS} 107-1 can be delayed allowing the transfer of the charge from the parasitic capacitances. On the other hand, if very small amount of charge, or no charge, flows from the parasitic capacitances due to, for example, a light load (or no load) condition, or simply because the parasitic capacitances have been mostly or fully discharged, low side switch MN_{LS} 107-1 can be turned on to reduce the deadtime when both low side and high side switches are off.

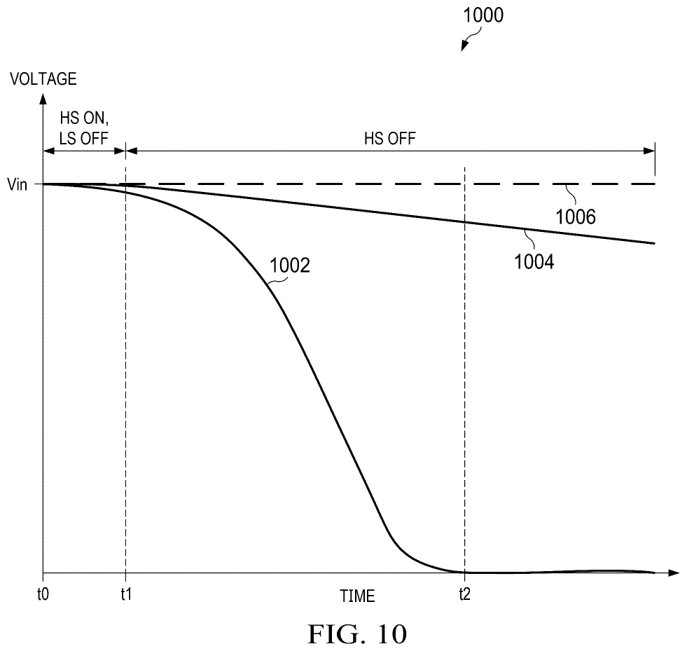

Reference is now made to FIG. 10, which illustrates a plot 1000 showing examples of operation of a buck converter, such as buck converter 701 of FIG. 7. Plot 1000 includes graphs 1002, 1004, and 1006 of various examples of variations of the switch node voltage (e.g., a voltage at switch node 704) with time under different load conditions. Graph 1002 illustrates an example variation of the switch node voltage under a large load condition, graph 1004 illustrates an example variation of the switch node voltage under a small load condition, and graph 1006 illustrates an example variation of the switch node voltage under a zero load condition.

Referring to FIG. 10, between times t0 and t1 is part of a first phase of a switching cycle, where high side switch MN_{HS} 107-2 is turned on and low side switch MN_{LS} 107-1 is turned off. The switch node voltage is at the input voltage Vin. The first phase ends at t1. Under a high load condition, as shown in graph 1002, charge stored in the parasitic capacitances of switch node 704 can be transferred through the inductor L to the load, which causes the switch node voltage to drop at a high rate. The discharge of the parasitic capacitances stops at time t2 when the stored charge is depleted, and the switch node voltage is at the ground voltage. It is advantageous to delay the enabling of low side switch MN_{LS} 107-1 while the switch node voltage drops at a high rate to maximize the transfer of the charge from the parasitic capacitances to the load to improve power efficiency. Also, when the charge transfer is almost complete due to the charge in the parasitic capacitance being depleted (at time t2 for a high load condition), where switch node voltage reaches ground voltage, or in cases where charge transfer is almost non-existing because there is light load or no load, as represented in graphs 1004 and 1006, where switch node voltage stays at Vin or drops at a very low rate), it is also advantageous to enable low side switch MN_{LS} 107-1 to reduce the deadtime.

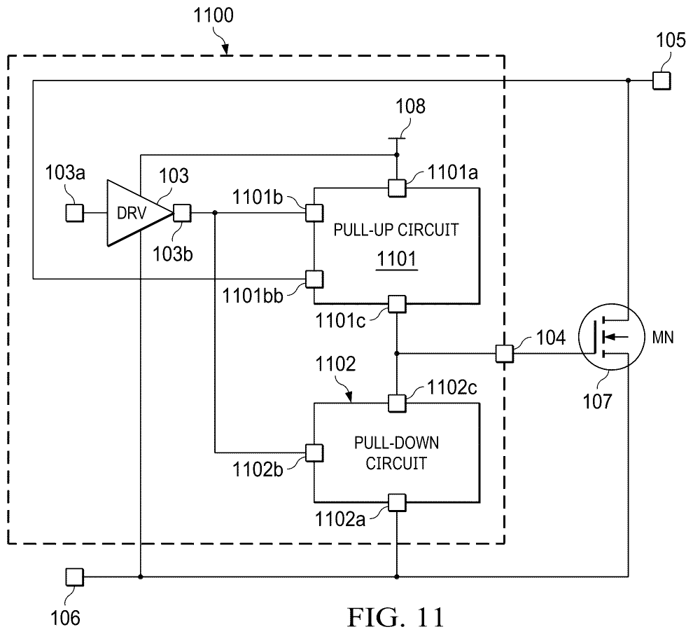

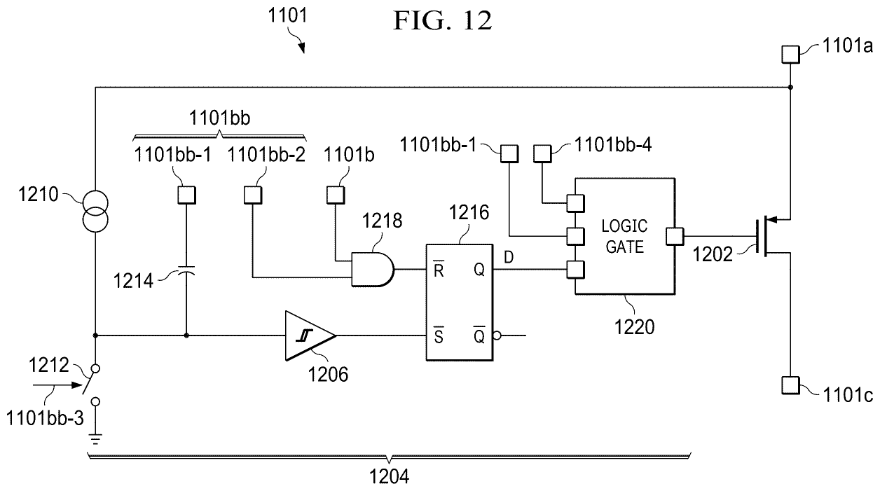

FIGS. 11 and 12 are schematics illustrating a control circuit 1100 for transistor MN 107, in accordance with at least one example. Transistor MN 107 is coupled between first current terminal 105 and second current terminal 106. Transistor MN 107 can be a low side switch MN_{LS} of buck converter 701, first current terminal 105 can be (or coupled to) switch node 704, and second current terminal 106 can be (or coupled to) ground.

In at least one example, control circuit 1100 comprises a pull-up circuit 1101, a pull-down circuit 1102, and driver 103. Driver 103 receives a modulated signal (e.g., a pulse width modulation signal and/or a frequency modulation signal) at a driver input 103a and provides an output at a driver output 103b that controls the logic level of a transistor control terminal 104 via pull-up circuit 1101 and pull-down circuit 1102.

Referring to FIG. 11, pull-up circuit 1101 includes a pull-up bias 1101a, a first pull-up control input 1101b, a second pull-up control input 1101bb, and a pull-up output 1101c, where pull-up bias 1101a is coupled to a supply rail 108, first pull-up control input 1101b is coupled to driver output 103b, second pull-up control input 1101bb can be a sense input coupled to first current terminal 105 (switch node 704). In some examples, second pull-up control input includes multiple sense inputs/terminals, with one sense terminal coupled to switch node 704 and another sense terminal coupled to the control terminal of high side switch MN_{HS} 107-2. Pull-up output 1101c is coupled to transistor control terminal 104, which is coupled to a gate of transistor MN 107. Pull-up circuit 1101 includes a switch (e.g., a transistor) coupled between pull-up bias 1101a and pull-up output 1101c. As to be described below, the switch can connect or disconnect between pull-up bias 1101a and pull-up output 101c responsive to a state of first pull-up control input 1101b (from driver 103), as well as a state of second pull-up control input 1101bb that indicate, for example, the voltage level of the switch node, a rate of change of the voltage of the switch node, and the voltage level of the control terminal of the high side switch.

In at least one example, pull-down circuit 1102 includes a pull-down bias 1102a, pull-down control input 1102b, and a pull-down output 1102c, where pull-down bias 1102a is coupled to second current terminal 106, first pull-down control input 1102b is coupled to first current terminal 105, pull-down control input 1102b is coupled to driver output 103b, and pull-down output 1102c is coupled to transistor control terminal 104. Pull-down circuit 1102 includes a switch coupled between pull-down output 1102c and pull-down bias 1102a. The switch can connect or disconnect between pull-down output 1102c and pull-down bias 1102a responsive to a state of pull-down control input 1102b (set by driver 103). In some examples, pull-down circuit 1102 can include examples of pull-down circuit 102 of FIGS. 1-9 and can also include a VDS clamp mechanism. In such examples, pull-down circuit 1102 may include additional input coupled to first current terminal 105, which are not shown in FIG. 11 for brevity.

FIG. 12 illustrates examples of internal components of pull-up circuit 1101. Referring to FIG. 12, pull-up circuit 1101 includes a switch 1202 (e.g., a p-type transistor) coupled between pull-up bias 1101a and pull-up output 1101c. The control terminal of switch 1202 is coupled to a control circuit 1204 coupled to first pull-up control input 1101b and second pull-up control input 1101bb including, for example, sense terminals 1101bb-1, 1101bb-2, and control inputs 1101bb-3 and 1101bb-4. Control circuit 1204 includes an inverter (or a Schmitt trigger) 1206 having an input and an output. The input of buffer or inverter 1206 is coupled to a current source 1210, a switch 1212, and a capacitor 1214. Current source 1210 is coupled between pull-up bias 1101a and the input of inverter 1206. A control terminal of switch 1212 is coupled to control terminal 1101bb-3. Capacitor 1214 is coupled between sense terminal 1101bb-1 and the input of inverter 1206. Control circuit 1204 also includes an R-S latch 1216 and a logic gate (e.g., AND gate) 1218. The inputs of AND gate 1218 are coupled to sense terminal 1101bb-2 and first pull-up control input 1101b, and the output of AND gate 1218 is coupled to a reset (R) input of R-S latch 1216. The output of R-S latch 1216 is coupled to the control terminal of switch 1202 via a logic gate 1220 (e.g., a NOR gate). Another input of logic gate 1220 is coupled to control input 1101bb-4, which can provide an enable signal indicating delaying of turning on of transistor MN 107 is enabled. Yet another input of logic gate 1220 is coupled to sense terminal 1101bb-1, which is coupled to first current terminal 105 of FIG. 11 (e.g., coupled to switch node 704).

In some examples, logic gate 1218 receives a signal from sense terminal 1101bb-2 indicative of whether the high side switch MN_{HS} is off. The signal can indicate, for example, whether the gate-source voltage (VGS) of high side switch MN_{HS} 107-2 is zero (or below a threshold voltage of the transistor). Logic gate 1218 also receives the modulated signal from driver 103 via first pull-up control input 1101b. During the first phase of the switching cycle where the high side switch is on and the low side switch is off, pull-up control input 1101b or sense terminal 1101bb-2 are in the de-asserted logic state, and logic gate 1218 can output a signal to the reset input (R) of R-S latch 1216. At the start of the second phase of the switching cycle where the high side switch is off, both pull-up control input 1101b or sense terminal 1101bb-2 can be in an asserted logic state, and, logic gate 1218 can output a signal to the release R-S latch 1216 out of the reset state. Prior to being set, the output of R-S latch 1216 can remain in the de-asserted logic state. If a state of input terminal 1101bb-4 also indicates that delaying of turning on of transistor MN 107 is enabled, logic gate 1220 can disable switch 1202 to prevent switch 1202 from pulling up the voltage of control terminal 104 of transistor MN 107 (the low side switch), hence the low side switch remains turned off.

Also, sense terminal 1101bb-1 can be coupled to first current terminal 105 of FIG. 11 (e.g., coupled to switch node 704) as described above. Capacitor 1214 and current source 1210 together can provide a signal at the input of buffer or inverter 1206 that indicates whether the voltage of the switch node drops at a high rate (e.g., as shown in graph 1002 between t1-t2) or remains at close to a DC voltage (e.g., as shown in graphs 1004 and 1006 after t1, or as shown in graph 1002 after t2). The voltage at input of buffer or inverter 1206 can be initialized at zero (ground voltage) by closing switch 1212, which is then opened to start the sensing operation. If the voltage of the switch node drops at a high rate, capacitor 1214 can counter current source 1210 (e.g., by diverting away current from current source 1210 from the input of inverter 1206), and the voltage at the input of inverter 1206 can remain at zero. Accordingly, R-S latch 1216 is not set and remains in the reset state, thus further delaying the turning on of the transistor.

On the other hand, if the voltage at the switch node stays at a DC level (e.g., at Vin or at zero volts), capacitor 1214 can block the DC voltage and does not divert away the current provided by current source 1210, and current source 1210 can bring up the input voltage (and output voltage) of inverter 1206, and R-S latch 1216 can be set. With R-S latch 1216 in a set state, logic gate 1220 can enable switch 1202 and pull up the voltage of control terminal 104 of transistor MN 107, thereby enabling the low side switch. Also, if the voltage at the switch node is at zero volt (or below a threshold voltage), logic gate 1220 can also enable switch 1202 and pull up the voltage of control terminal 104 of transistor MN 107, thereby enabling the low side switch.

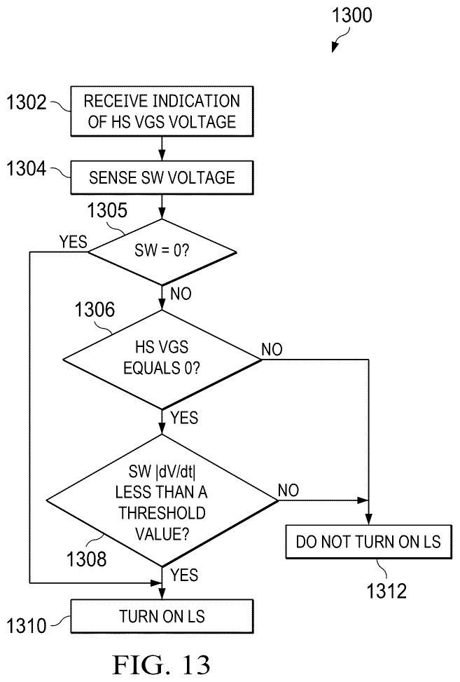

FIG. 13 is a flowchart 1300 of a method of controlling a low side switch, in accordance with at least one example. At least some of the operations of flowchart 1300 can be performed by pull-up circuit 1101 of FIGS. 11 and 12. At block 1302, an indication of high side switch gate-source voltage (VGS) is received. That indication can be received via, for example, sense terminal 1101bb-2 of FIG. 11. The indication can be based on, for example, sensing the VGS voltage of the high side switch, sensing a state of the modulated signal provided to driver 103, etc.

At block 1304, the voltage at the switch node is received. The voltage can be received via, for example, sense terminal 1101bb-1.

At block 1305, a decision is made about whether the voltage at the switch node is at zero (or below a threshold). If the voltage is at zero (or below a threshold), pull-up circuit 1101 can proceed to block 1310 and turn on the low side switch. If the voltage is non-zero (or above the threshold), pull-up circuit 1101 can proceed to block 1306.

At block 1306, a decision is made about whether the VGS voltage of the high switch equals zero (or below a threshold), which indicates whether the high side switch is off. If the high side switch is not off, pull-up circuit 1101 can proceed to block 1312 and hold off on turning on the low side switch. This can be performed by, for example, first resetting R-S latch 1216 and then releasing R-S latch 1216 from the reset state.

If the high side switch is off, pull-up circuit 1101 can proceed to block 1308 (e.g., by not keeping R-S latch 1216 in the reset state). At block 1308, a decision is made about whether a rate of change of the voltage at the switch node (dV/dt) exceeds a threshold. This is performed by, for example, capacitor 1214 together with current source 1210. If the rate of change is above a threshold, pull-up circuit 1101 can proceed to block 1312 and hold off on turning on the low side switch. This can be performed by, for example, capacitor 1214 diverting current provided by current source 1210 from the input of inverter 1206 to prevent the R-S latch from entering the set state.

On the other hand, if the rate of change is below a threshold (e.g., at close to DC), pull-up circuit 1101 can proceed to block 1310 and turn on the low side switch. This can be performed by, for example, capacitor 1214 blocking the DC voltage and/or not diverting current provided by current source 1210, which allows current source 1210 to charge up the input of inverter 1206 and set R-S latch 1216. With R-S latch 1216 in the set state, pull-up circuit 1101 is enabled to pull up the voltage on the control terminal of the low side switch and turn on the low side switch.

The following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementations without changing the scope of disclosure.

Example 1 is an apparatus comprising: a transistor coupled between a first current terminal and a second current terminal, the transistor having a transistor control terminal; a driver circuit having a driver input and a driver output; a pull-up circuit having a first bias terminal, a pull-up control input and a pull-up output, the first bias terminal coupled to a power terminal, the pull-up control input coupled to the driver output, and the pull-up output coupled to the transistor control terminal; and a pull-down circuit having a second bias terminal, a first pull-down control input, a second pull-down control input, and a pull-down output, the second bias terminal coupled to the second current terminal, the first pull-down control input coupled to the first current terminal, the second pull-down control input coupled to the driver output, and the pull-down output coupled to the transistor control terminal.

Example 2 is an apparatus according to any example herein, in particular example 1, wherein the pull-up circuit is configurable to, responsive to the driver output having a first state, connect the transistor control terminal to the power terminal; and wherein the pull-down circuit is configurable to: responsive to the driver output having a second state, and a first voltage at the first current terminal being below a threshold, connect the transistor control terminal to the second current terminal; and responsive to the driver output having the second state and the first voltage at the first current terminal being above the threshold, set the transistor control terminal to a second voltage above a third voltage of the second current terminal.

Example 3 is an apparatus according to any example herein, in particular example 1, wherein the pull-down circuit includes: a first switch coupled between the pull-down output and the second bias terminal, the first switch having a first switch control terminal coupled to the first pull-down control input; and a second switch and a resistor coupled between the pull-down output and the second bias terminal, the second switch having a second switch control terminal coupled to the second pull-down control input.

Example 4 is an apparatus according to any example herein, in particular example 3, wherein the second switch has a higher on-resistance than the first switch.

Example 5 is an apparatus according to any example herein, in particular example 3, wherein the pull-down circuit includes: a third switch coupled between the power terminal and the first switch control terminal, the third switch having a third switch control terminal; and a pulse generator coupled between the second pull-down control input and the third switch control terminal.

Example 6 is an apparatus according to any example herein, in particular example 3, wherein the pull-down circuit includes: a high pass filter having a filter input and a filter output, the filter input coupled to the first pull-down control input; a reference generator coupled between the power terminal and the second current terminal, the reference generator having a reference output; and a comparator having comparator inputs and a comparator output, the comparator inputs coupled to the filter output and the reference output, and the comparator output coupled to the first switch control terminal.

Example 7 is an apparatus according to any example herein, in particular example 6, wherein the high pass filter includes a capacitive divider.

Example 8 is an apparatus according to any example herein, in particular example 6, further comprising: a current source coupled between the power terminal and first switch control terminal; and a third switch coupled between the first switch control terminal and the second bias terminal, the third switch having a third switch control terminal coupled to the comparator output.

Example 9 is an apparatus according to any example herein, in particular example 6, wherein the transistor is a first transistor, the transistor control terminal is a first transistor control terminal, and the reference generator includes: a bias generation circuit having a bias output; a second transistor having a second transistor control terminal coupled to the bias output; a proportional absolute temperature current sink; a resistor; and a current summation circuit having a first current input, a second current input, and a summation output, the first current input coupled to the second transistor, the second current input coupled to the proportional absolute temperature current sink, and the summation output coupled to the reference output and the resistor.

Example 10 is an apparatus according to any example herein, in particular example 6, wherein the comparator has an enable input, and the pull-down circuit includes a delay circuit coupled between the second pull-down control input and the enable input.

Example 11 is an apparatus according to any example herein, in particular example 1, wherein the transistor is a low side switch of a half bridge, the first current terminal is coupled to a switching terminal of the half bridge, and the second current terminal is coupled to a ground terminal.

Example 12 is an apparatus according to any example herein, in particular example 1, wherein the transistor is a high side switch of a half bridge, the first current terminal is coupled to a power input of the half bridge, and the second current terminal is coupled to a switching terminal of the half bridge.

Example 13 is an apparatus according to any example herein, in particular example 1, wherein the transistor is part of a buck converter.

Example 14 is an apparatus according to any example herein, in particular example 1, wherein the transistor is a main switch of a boost converter, the first current terminal coupled to an inductor terminal, and the second current terminal coupled to a ground terminal.

Example 15 is an apparatus according to any example herein, in particular example 1, wherein the transistor is a rectifier switch of a boost converter, the first current terminal coupled to an inductor terminal, and the second current terminal coupled to a power output.

Example 16 is an apparatus according to any example herein, in particular example 2, wherein the pull-up circuit is disabled responsive to a voltage transition rate of the first current terminal exceeding a threshold.

Example 17 is an apparatus according to any example herein, in particular example 2, wherein the pull-down circuit is enabled responsive to a voltage of the first current terminal being equal to zero.

Example 18 is a system comprising: a load; an inductor coupled to the load; a capacitor coupled to the inductor and the load; and a DC-DC converter coupled to the inductor, the DC-DC converter comprising: a transistor coupled between a first current terminal and a second current terminal, the transistor having a transistor control terminal; a driver circuit having a driver input and a driver output; a pull-up circuit having a first bias terminal, a pull-up control input and a pull-up output, the first bias terminal coupled to a power terminal, the pull-up control input coupled to the driver output, and the pull-up output coupled to the transistor control terminal; and a pull-down circuit having a second bias terminal, a first pull-down control input, a second pull-down control input, and a pull-down output, the second bias terminal coupled to the second current terminal, the first pull-down control input coupled to the first current terminal, the second pull-down control input coupled to the driver output, and the pull-down output coupled to the transistor control terminal.

Example 19 is a method comprising: receiving a control signal to disable a transistor; receiving a first voltage from a current terminal of the transistor; responsive to the control signal and the first voltage exceeding a threshold, setting a control terminal of the transistor to a second voltage to enable the transistor; and responsive to the first voltage being below the threshold, disabling the transistor.

Example 20 is a method according to any example herein, in particular example 19, wherein the control signal is a first control signal, and the method further comprises: receiving a second control signal to enable the transistor; and responsive to the second control signal, setting the control terminal of the transistor to a third voltage to enable the transistor, in which the third voltage is higher than the second voltage, wherein the transistor is a: high side switch of a half bridge, a low side switch of the half bridge, a main switch of a boost converter, or a rectifier switch of the boost converter.

Example 21 is an apparatus comprising: a transistor having a current terminal and a transistor control terminal; a voltage transition sensing circuit having a sense input and a sense output, the sense input coupled to the current terminal; and a control circuit having a control input and a control output, the control input coupled to the sense output, and the control output coupled to the transistor control terminal.

Example 22 is an apparatus according to any example herein, in particular example 21, wherein the sense input is a first sense input, the sense output is a first sense output, the control input is a first control input, the control circuit has a second control input, and the apparatus further comprises a voltage level sense circuit having a second sense input and a second sense output, the second sense input coupled to the current terminal.

Example 23 is an apparatus according to any example herein, in particular example 22, wherein the transistor is a first transistor, the transistor control terminal is a first transistor control terminal, the voltage level sense circuit is a first voltage level sense circuit, the control circuit has a third control input, and the apparatus further comprises: a second transistor coupled to the current terminal; and a second voltage level sense circuit having a third sense input and a third sense output, the third sense input coupled to a second transistor control terminal of the second transistor, and the third sense output coupled to the third control input.

Example 24 is an apparatus according to any example herein, in particular example 23, wherein the control circuit is configurable to enable the first transistor to be responsive to a state of the third control input indicating that the second transistor is disabled, and a state of the first control input indicating that a transition rate of a voltage at the current terminal is below a threshold, or a state of the second control input indicating that the voltage is at zero.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

In the description and in the claims, the terms “including” and “having,” and variants thereof are intended to be inclusive in a manner similar to the term “comprising” unless otherwise noted. In addition, the terms “couple,” “coupled,” or “couples” means an indirect or direct electrical or mechanical connection.

Also, in this description, the recitation “based on” means “based at least in part on.” Therefore, if X is based on Y, then X may be a function of Y and any number of other factors.

A device that is “configured to” or “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics, or semiconductor component.

A circuit or device that is described herein as including certain components may instead be adapted to be coupled to those components to form the described circuit or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuit. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN), or a gallium arsenide substrate (GaAs).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means being within +/−10 percent of that parameter or, if the parameter is zero, a reasonable range of values around zero.

What is claimed is:

1. An apparatus comprising:
a transistor coupled between a first current terminal and a second current terminal, the transistor having a transistor control terminal;
a driver circuit having a driver input and a driver output;
a pull-up circuit having a first bias terminal, a pull-up control input and a pull-up output, the first bias terminal coupled to a power terminal, the pull-up control input coupled to the driver output, and the pull-up output coupled to the transistor control terminal; and
a pull-down circuit having a second bias terminal, a first pull-down control input, a second pull-down control input, and a pull-down output, the second bias terminal coupled to the second current terminal, the first pull-down control input coupled to the first current terminal, the second pull-down control input coupled to the driver output, and the pull-down output coupled to the transistor control terminal.

2. The apparatus of claim 1, wherein the pull-up circuit is configurable to and responsive to the driver output having a first state, connect the transistor control terminal to the power terminal; and wherein the pull-down circuit is configurable to:
responsive to the driver output having a second state and a first voltage at the first current terminal being below a threshold, connect the transistor control terminal to the second current terminal; and
responsive to the driver output having the second state and the first voltage at the first current terminal being above the threshold, provide a second voltage above a third voltage of the second current terminal at the transistor control terminal.

3. The apparatus of claim 1, wherein the pull-down circuit includes:
a first switch coupled between the pull-down output and the second bias terminal, the first switch having a first switch control terminal coupled to the first pull-down control input; and
a second switch and a resistor coupled between the pull-down output and the second bias terminal, the second switch having a second switch control terminal coupled to the second pull-down control input.

4. The apparatus of claim 3, wherein the second switch has a higher on-resistance than the first switch.

5. The apparatus of claim 3, wherein the pull-down circuit includes:
a third switch coupled between the power terminal and the first switch control terminal, the third switch having a third switch control terminal; and
a pulse generator coupled between the second pull-down control input and the third switch control terminal.

6. The apparatus of claim 3, wherein the pull-down circuit includes:
a divider having a divider input and a divider output, the divider input coupled to the first pull-down control input;
a reference generator coupled between the power terminal and the second current terminal, the reference generator having a reference output; and
a comparator having comparator inputs and a comparator output, the comparator inputs coupled to the divider output and the reference output, and the comparator output coupled to the first switch control terminal.

7. The apparatus of claim 6, wherein the divider includes a capacitive divider.

8. The apparatus of claim 6, further comprising:
a current source coupled between the power terminal and the first switch control terminal; and
a third switch coupled between the first switch control terminal and the second bias terminal, the third switch having a third switch control terminal coupled to the comparator output.

9. The apparatus of claim 6, wherein the transistor is a first transistor, the transistor control terminal is a first transistor control terminal, and the reference generator includes:
a bias generation circuit having a bias output;
a second transistor having a second transistor control terminal coupled to the bias output;
a proportional absolute temperature current sink;
a resistor; and
a current summation circuit having a first current input, a second current input, and a summation output, the first current input coupled to the second transistor, the second current input coupled to the proportional absolute temperature current sink, and the summation output coupled to the reference output and the resistor.

10. The apparatus of claim 6, wherein the comparator has an enable input, and the pull-down circuit includes a delay circuit coupled between the second pull-down control input and the enable input.

11. The apparatus of claim 1, wherein the transistor is a low side switch of a half bridge, the first current terminal is coupled to a switching terminal of the half bridge, and the second current terminal is coupled to a ground terminal.

12. The apparatus of claim 1, wherein the transistor is a high side switch of a half bridge, the first current terminal is coupled to a power input of the half bridge, and the second current terminal is coupled to a switching terminal of the half bridge.

13. The apparatus of claim 1, wherein the transistor is part of a buck converter.

14. The apparatus of claim 1, wherein the transistor is a main switch of a boost converter, the first current terminal coupled to an inductor terminal, and the second current terminal coupled to a ground terminal.

15. The apparatus of claim 1, wherein the transistor is a rectifier switch of a boost converter, the first current terminal coupled to an inductor terminal, and the second current terminal coupled to a power output.

16. The apparatus of claim 2, wherein the pull-up circuit is enabled responsive to at least one of: a voltage transition rate of the first current terminal being below a first threshold, or a voltage of the first current terminal being below a second threshold.

17. A method comprising:
receiving a control signal to disable a transistor;
receiving a first voltage from a current terminal of the transistor;
responsive to the control signal and the first voltage exceeding a threshold, setting a control terminal of the transistor to a second voltage to enable the transistor; and
responsive to the first voltage being below the threshold, disabling the transistor.

18. The method of claim 17, wherein the control signal is a first control signal, and the method further comprises:
receiving a second control signal to enable the transistor; and
responsive to the second control signal, setting the control terminal of the transistor to a third voltage to enable the transistor, in which the third voltage is higher than the second voltage, wherein the transistor is a: high side switch of a half bridge, a low side switch of the half bridge, a main switch of a boost converter, or a rectifier switch of the boost converter.

19. An apparatus comprising:
a transistor having a current terminal and a transistor control terminal;
a voltage transition sensing circuit having a sense input and a sense output, the sense input coupled to the current terminal; and
a control circuit having a control input and a control output, the control input coupled to the sense output, and the control output coupled to the transistor control terminal, the control circuit configurable to, responsive to a voltage transition rate at the current terminal being below a first threshold or a voltage at the current terminal being below a second threshold, enable the transistor.

20. The apparatus of claim 19, wherein the transistor is a first transistor, the transistor control terminal is a first transistor control terminal, the control circuit has a second control input, and the apparatus further comprises:
a second transistor coupled to the current terminal; and
a voltage level sense circuit having a second sense input and a second sense output, the second sense input coupled to a second transistor control terminal of the second transistor, and the second sense output coupled to the second control input,
wherein the control circuit is configurable to, responsive to a voltage between the second transistor control terminal and the current terminal being below a third threshold, enable the first transistor.
